(19) United States
(12) Patent Application Publication
(10) Pub. No.: US 2012/0143715 A1
(43) Pub. Date: Jun. 7, 2012

(54) SPARSE INDEX BIDDING AND AUCTION BASED STORAGE

(76) Inventors: Kave Eshghi, Los Altos, CA (US); Mark Lillibridge, Mountain View, CA (US); John Czerkowicz, Northborough, MA (US)

(21) Appl. No.: 13/386,436

(22) PCT Filed: Oct. 26, 2009
(86) PCT No.: PCT/US2009/062056

§ 371 Date: Jan. 23, 2012

(51) Int. Cl. G06Q 30/08

(52) U.S. Cl. 705/26.3

(57) ABSTRACT

Illustrated is a system and method that includes a receiving module, which resides on a back end node, to receive a set of hashes that is generated from a set of chunks associated with a segment of data. Additionally, the system and method further includes a lookup module, which resides on the back end node, to search for at least one hash in the set of hashes as a key value in a sparse index. The system and method also includes a bid module, which reside on the back end node, to generate a bid, based upon a result of the search.

### CROSS REFERENCE TO RELATED APPLICATIONS

This is a non-provisional Patent Cooperation Treaty (PCT) patent application related to U.S. patent application Ser. No. 12/432,807 entitled “COPYING A DIFFERENTIAL DATA STORE INTO TEMPORARY STORAGE MEDIA IN RESPONSE TO A REQUEST” that was filed on Apr. 30, 2009, and which is incorporated by reference in its entirety.

### BACKGROUND

Data de-duplication refers to the elimination of redundant data. In the de-duplication process, duplicate data is deleted, leaving only one copy of the data to be stored. De-duplication is able to reduce the required storage capacity since only the unique data is stored. Types of de-duplication include out-of-line de-duplication, and inline de-duplication. In out-of-line de-duplication, the incoming data is stored in a large holding area in raw form, and de-duplication is performed periodically, on a batch basis. In inline de-duplication data streams are de-duplicated as they are received by the storage device.

### BRIEF DESCRIPTION OF THE DRAWINGS

Some embodiments of the invention are described, by way of example, with respect to the following figures:

FIG. 1 is a diagram of a system, according to an example embodiment, illustrating auction-based a sparse index routing algorithm for scaling out data stream de-duplication.

FIG. 2 is a diagram of a system, according to an example embodiment, illustrating the logical architecture for a system and method for auction-based sparse index routing.

FIG. 3 is a diagram of a system, according to an example embodiment, illustrating the logic architecture for a system and method for auction-based sparse index routing showing the generation of hooks and bids.

FIG. 4 is a diagram of a system, according to an example embodiment, illustrating a logical architecture for a system and method for auction-based sparse index routing showing storage of de-duplication data after a winning bid.

FIG. 5 is a block diagram of a computer system, according to an example embodiment, to generate bids for auction based sparse index routing.

FIG. 6 is a block diagram of a computer system, according to an example embodiment, to select a winning bid using a front end node.

FIG. 7 is a block diagram of a computer system, according to an example embodiment, to select a winning bid using a front end node.

FIG. 8 is a flow chart illustrating a method, according to an example embodiment, to generate bids for auction based sparse index routing using a back end node.

FIG. 9 is a flow chart illustrating a method, according to an example embodiment, to select a winning bid using a front end node.

FIG. 10 is a flow chart illustrating a method, according to an example embodiment, encoded on a computer readable medium to select a winning bid using a front end node.

FIG. 11 is a dual-stream flow chart illustrating method, according to an example embodiment, to bid for, and to de-duplicate data, prior to storage within an auction-based sparse index routing system.

FIG. 12 is a diagram of an operation, according to an example embodiment, to analyze bids to identify a winning bid amongst various submitted bids.

FIG. 13 is a diagram illustrating a system, according to an example embodiment, mapping a sparse index to a secondary storage.

FIG. 14 is a diagram of a computer system, according to an example embodiment.

### DETAILED DESCRIPTION

A system and method is illustrated for routing data for storage using auction-based sparse-index routing. Through the use of this system and method, data is routed to back end nodes that manage secondary storage such that similar segments of this data are likely to end up on the same back end node. Where the data does end up on the same back end node, the data is de-duplicated and stored. As is illustrated below, a back end node bids in an auction against other back end nodes for the data based upon similar sparse index entries already managed by the back end node. Each of these back end nodes is autonomous such that a given back end node does not make reference to data managed by other back end nodes. There is no sharing of chunks between nodes, each node has its own index, and housekeeping, including garbage collection, is local.

In some example embodiments, a system and method for chunk-based de-duplication using sparse indexing is illustrated. In chunk-based de-duplication, a data stream is broken up into a sequence of chunks, the chunk boundaries determined by content. The determination of chunk boundaries is made to ensure that shared sequences of data yield identical chunks. Chunk based de-duplication relies on identifying duplicate chunks by performing, for example, a bit-by-bit comparison, a hash comparison, or some other suitable comparison. Chunks whose hashes are identical may be deemed to be the same, and their data is stored only once.

Some example embodiments include breaking up a data stream into a sequence of segments. Data streams are broken into segments in a two step process: first, the data stream is broken into a sequence of variable-length chunks, and then the chunk sequence is broken into a sequence of segments. Two segments are similar, if they share a number of chunks. As used herein, segments are units of information storage and retrieval. As used herein, a segment is a sequence of chunks. An incoming segment is de-duplicated against existing segments in a data store that are similar to it.

In some example embodiments, the de-duplication of similar segments proceeds in two steps: first, one or more stored segments that are similar to the incoming segment are found; and, second, the incoming segment is de-duplicated against those existing segments by finding shared/duplicate chunks using hash comparison. Segments are represented in the secondary storage using a manifest. As used herein, a manifest is a data structure that records the sequence of hashes of the segment's chunks. The manifest may optionally include metadata about these chunks, such as their length and where they are stored in secondary storage (e.g., a pointer to the actual stored data). Every stored segment has a manifest that is stored in secondary storage.

In some example embodiments, finding of segments similar to the incoming segment is performed by sampling the chunk hashes within the incoming segment, and using a sparse index. Sampling may include using a sampling characteristic (e.g., a bit pattern) such as selecting as a sample every hash whose first seven bits are zero. This leads to an average sampling rate of 1/128 (i.e., on average 1 in every 128 hashes is chosen as a sample). The selected hashes are referenced herein as hash hooks (e.g., hooks). As used herein, a sparse index is an in-Random Access Memory (RAM) key-value map. As used herein, in RAM is non-persistent storage. The key for each entry is a hash hook that is mapped to one or more pointers, each to a manifest in which that hook occurs. The manifests are kept in secondary storage.

In one example embodiment, to find stored segments similar to the incoming segment, the hooks in the incoming segment are determined using the above referenced sampling method. The sparse index is queried with the hash hooks (i.e., the hash hooks are looked up in the index) to identify using the resulting pointer(s) (i.e., the sparse index values) one or more stored segments that share hooks with the incoming segment. These stored segments are likely to share other chunks with the incoming segment (i.e., to be similar to the incoming segment) based upon the property of chunk locality. Chunk locality, as used herein, refers to the phenomenon that when two segments share a chunk, they are likely to share many subsequent chunks. When two segments are similar, they are likely to share more than one hook (i.e., the sparse index lookups of the hooks of the first segment will return the pointer to the second segment's manifest more than once).

In some example embodiments, through leveraging the property of chunk locality, a system and method for routing data for storage using auction-based sparse-index routing may be implemented. The similarity of a stored segment and the incoming segment is estimated by the number of pointers to that segment's manifest returned by the sparse index while looking up the incoming segment's hooks. As is illustrated below, this system and method for routing data for storage using auction-based sparse-index routing is implemented using a distributed architecture.

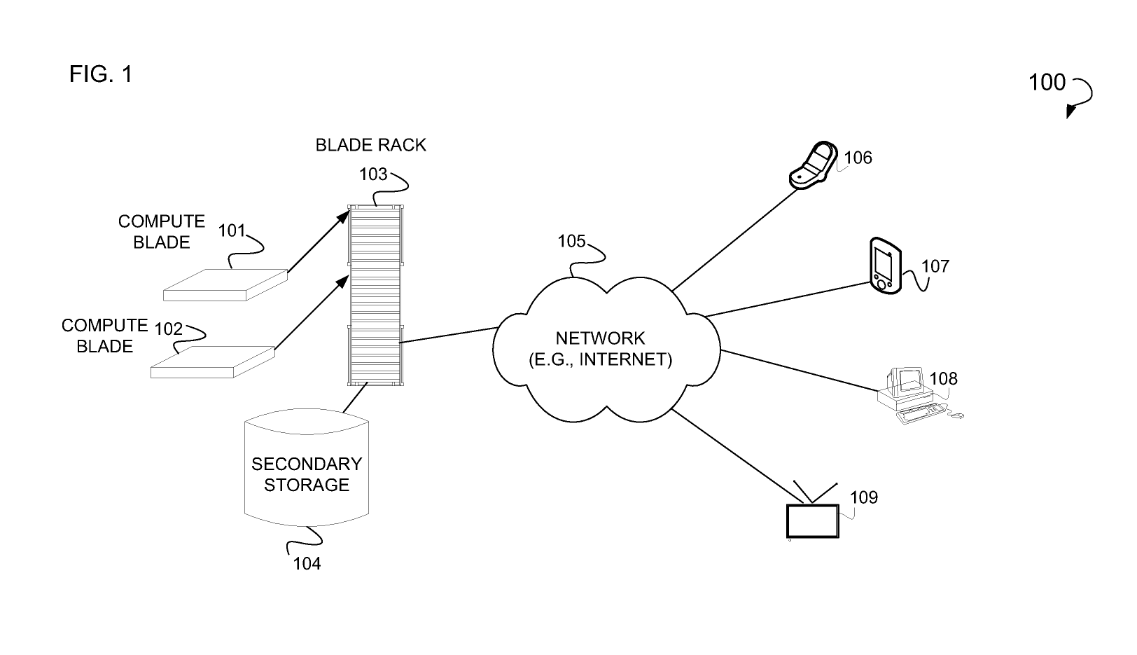

FIG. 1 is a diagram of an example system 100 illustrating an auction-based sparse index routing algorithm for scaling out data stream de-duplication. Shown are a compute blade 101 and a compute blade 102 each of which is positioned proximate to a blade rack 103. A compute blade, as referenced herein, is a computer system with memory to read input commands and data, and a processor to perform commands manipulating that data. The compute blades 101 through 102 are operatively connected to the network 105 via a logical or physical connection. As used herein, operatively connected includes a logical or physical connection. The network 105 may be an internet, an intranet, a Wide Area Network (WAN), a Local Area Network (LAN), or some other network and suitable topology associated with the network. In some example embodiments, operatively connected to the network 105 is a plurality of devices including a cell phone 106, a Personal Digital Assistant (PDA) 107, a computer system 108 and a television or monitor 109. In some example embodiments, the compute blades 101 through 102 communicate with the plurality of devices via the network 105. Also shown is a secondary storage 104. This secondary storage 104, as used herein, is persistent computer memory that uses its input/output channels to access stored data and transfers the stored data using intermediate area in primary storage. Examples of secondary storage include magnetic disks (e.g., hard disks), optical disks (e.g., Compact Discs (CDs), and Digitally Versatile Discs (DVDs)), flash memory devices (e.g. Universal Serial Bus (USB) flash drives or keys), floppy disks, magnetic tapes, standalone RAM disks, and zip drives. This secondary storage 104 may be used in conjunction with a database server (not pictured) that manages the secondary storage 104.

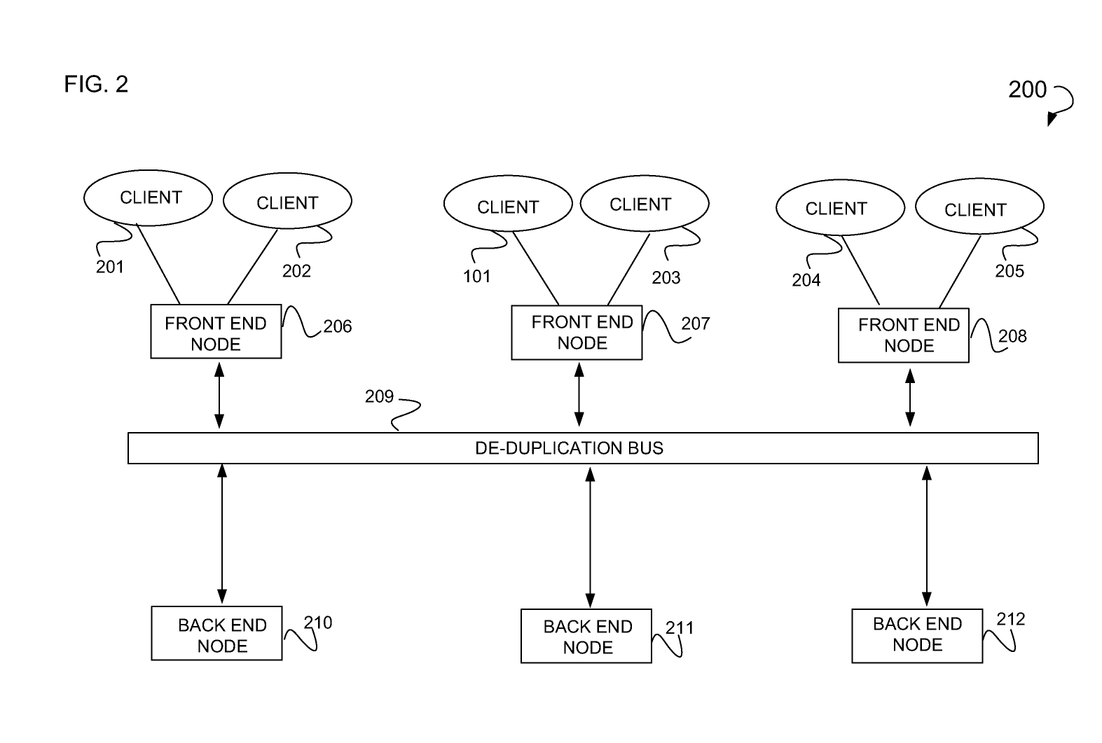

FIG. 2 is a diagram of an example system 200 illustrating the logical architecture for a system and method for auction-based sparse index routing. Shown are clients 201 through 205, and client 101. The clients 201 through 205 may be computer systems that include compute blades. Clients 201 and 202 are operatively connected to a front end node 206. Clients 101 and 203 are operatively connected to front end node 207. Clients 204 and 205 are operatively connected to front end node 208. The front end nodes 206 through 208 are operatively connected to a de-duplication bus 209. The de-duplication bus 209 may be a logical or physical connection that allows for asynchronous communication between the front end nodes 206 through 208, and back end nodes 210 through 212. These back end nodes 210 through 212 are operatively connected to the de-duplication bus 209. In some example embodiments, the front end nodes 206 through 208 reside upon one or more of the clients 201 through 205 and 101 (e.g., computer systems). For example, the front end node 206 may reside upon the client 201 or client 202. In some example embodiments, the front end nodes 206 through 208 reside upon a database server (e.g., a computer system) that is interposed between the blade rack 103 and the secondary storage 104. Further, in some example embodiments, the back end nodes 210 through 212 reside upon a database server that is interposed between the blade rack 103 and the secondary storage 104. Additionally, in some example embodiments, back end nodes 210 through 212 reside on one or more of the clients 201 through 205, and 101.

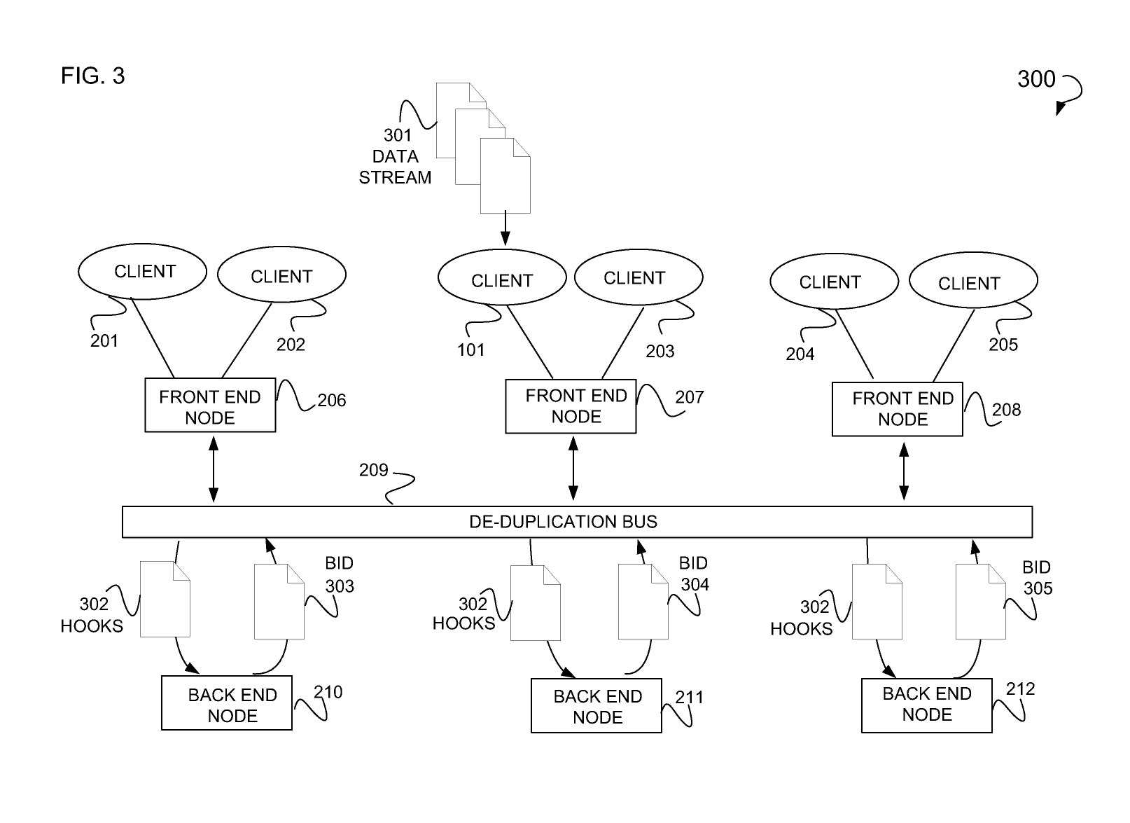

FIG. 3 is a diagram of an example system 300 illustrating the logic architecture for a system and method for auction-based sparse index routing showing the generation of hooks and bids. Shown is a data stream 301 being received by the client 101. The client 101 provides this data stream 301 to the front end node 207. The front end node 207 parses this data stream 301 into segments and chunks. Chunks are passed through one or more hashing functions to generate a hash of each of the chunks (i.e., collectively referenced as hashed chunks). These hashes are sampled to generate a hook(s) 302. The sampling, as is more fully illustrated below, may occur at some pre-defined rate where this rate is defined by a system administrator or a sampling algorithm. The hook(s) 302 are broadcast by the front end node 207 using the de-duplication bus 209 to the back end nodes 210 through 212. The back end nodes 210 through 212 receive the hook(s) 302 and each looks up the hook(s) 302 in their separate sparse index that is unique to them. Each unique sparse index resides upon one of the back end nodes 210 through 212. In some example embodiments, based upon the number of times the hook(s) 302 appears within the sparse index (i.e., how many of the hooks appear as a key in the index) a bid is generated. This bid reflects, for example, the number of times the hook(s) (e.g., the hashes) appear within a particular sparse index. In some example embodiments, the bid is based upon the lookup of the hooks in the sparse index and the number of pointers and reference values associated with them (i.e., the values associated with the hooks). Each back end node transmits its bid to the requesting, broadcasting front end node. Here, for example, in response to the broadcasting of the hook(s) 302, the back end node 210 transmits the bid 303, the back end node 211 transmits the bid 304, and the back end node 212 transmits the bid 305.

In one example embodiment, if five hooks are generated through sampling, and included in the hook(s) 302, and all five hooks are found to exist as part of the spare index residing on the back end node 212, then the bid 305 may include a bid value of five. Further, if bid 305 is five, and bids 303, and 304 are zero, then bid 305 would be a winning bid. A winning bid, as used herein, is a bid that is selected based upon some predefined criteria. These predefined criteria may be a bid that is higher than, or equal to, other submitted bids. In other example embodiments, these predefined criteria may be that the bid is lower than, or equal to other submitted bids.

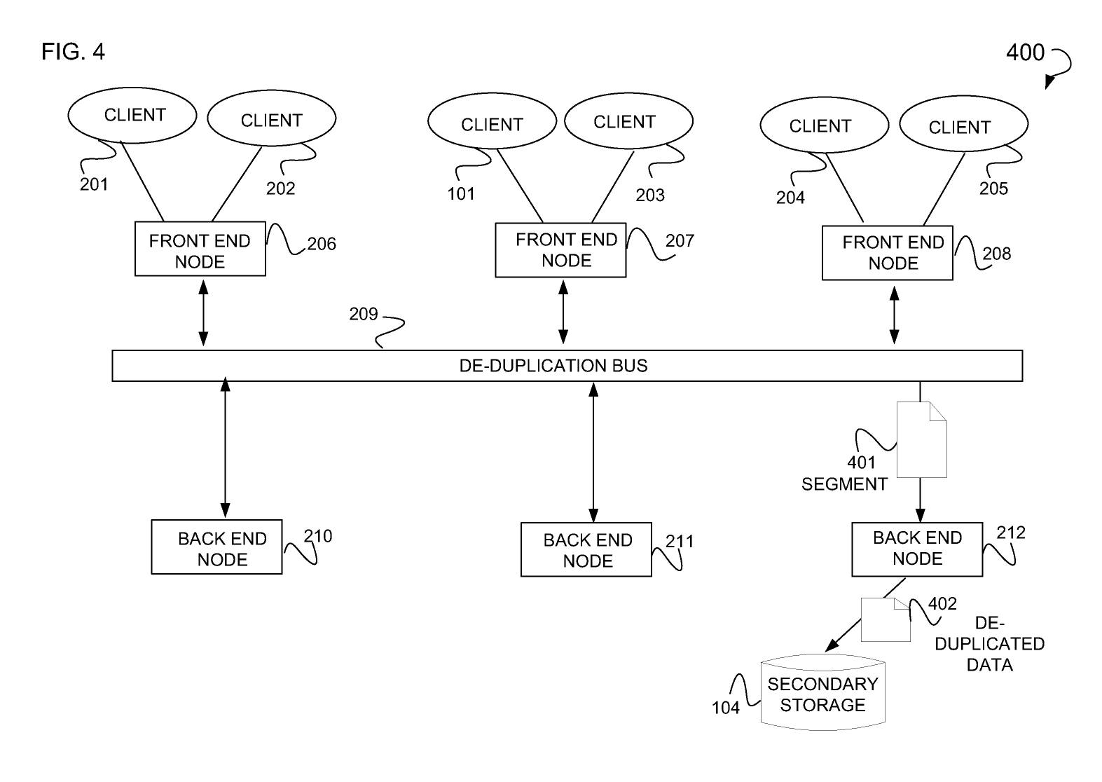

FIG. 4 is a diagram of an example system 400 illustrating a logical architecture for a system and method for auction-based sparse index routing showing storage of de-duplication data after a winning bid. Shown is a segment 401 that is transmitted by the front end node 207 after receiving a winning bid, in the form of the bid 305, from the back end node 212. This segment 401 includes the hashed chunks referenced in FIG. 3. This segment 401 is provided to the back end node 212. The back end node 212 processes this segment 401 by determining which of the chunks associated with segment 401 already reside in the secondary storage 104. This determination is based upon finding duplicate chunks that are part of the segment 401. Where a chunk of segment 401 is deemed to be a duplicate of data existing in the secondary storage 104, that chunk is discarded. Where that chunk is not found to be a duplicate, that chunk is stored into the secondary storage 104 by the back end node 212.

In some example embodiments, the de-duplication process is orchestrated by the front end node 207. Specifically, in this embodiment, the front end node determines where the segment 401 has duplicate chunks. If duplicate chunks are found to exist, then they are discarded. The remaining chunks are transmitted to the back end node 212 for storage.

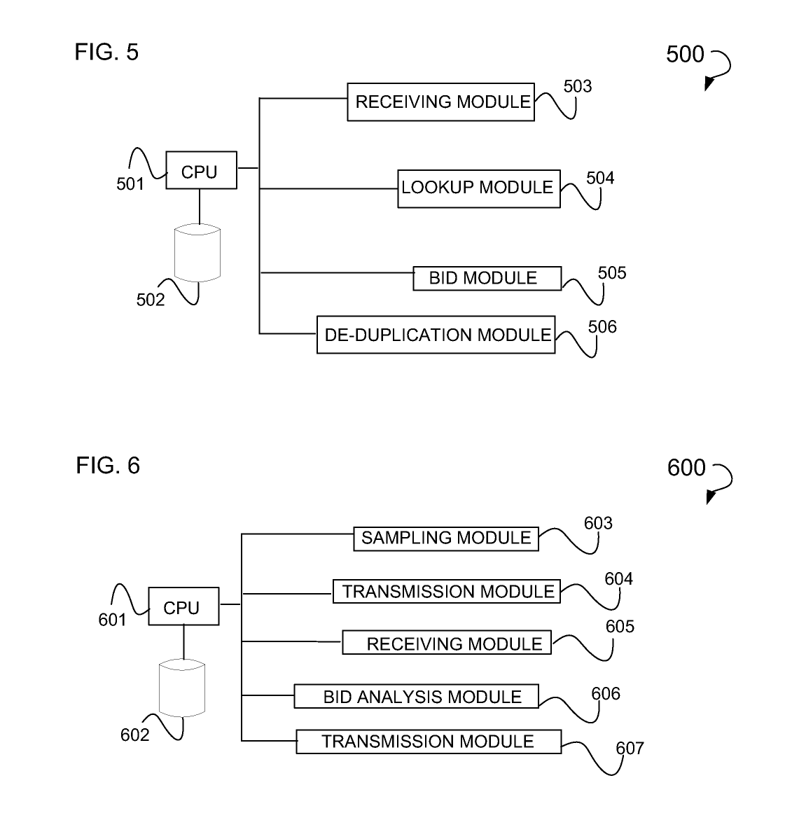

FIG. 5 is a block diagram of an example computer system 500 to generate bids for auction based sparse index routing. These various blocks may be implemented in hardware, firmware, or software as part of the back end node 212. Illustrated is a Central Processing Unit (CPU) 501 that is operatively connected to a memory 502. Operatively connection to the CPU 501 is a receiving module 503 to receive a set of hashes that is generated from a set of chunks associated with a segment of data. Operatively connected to the CPU 501 is a lookup module 504 to search for at least one hash in the set of hashes as a key value in a sparse index. A search, as used herein, may be a lookup operation. Additionally, operatively connected to the CPU 501 is a bid module 505 to generate a bid, based upon a result of the search. Operatively connected to the CPU 501 is a de-duplication module 506 that receives the segment of data, and de-duplicates the segment of data through the identification of a chunk, of the set of chunks associated with the segment of data, that is already stored in a data store (e.g., the memory 502) operatively connected to the back end node 212. In some example embodiments, the de-duplication module 506 instead receives a further set of hashes. Additionally, the de-duplication module 506 identifies a hash, of the further set of hashes, whose associated chunk is not stored in a data store operatively connected to the back end node 212. Further, the de-duplication module 506 may store the associated chunk. In some example embodiments, the further set of hashes is received from the receiving module 503, and the set of hashes and the further set of hashes are identical. In some example embodiments, the set of hashes is selected from a plurality of hashes using a sampling method, the plurality of hashes generated from the set of chunks associated with the segment of data. Further, in some example embodiments, the bid module bases the bid on a number of matches found by the lookup module. The bid may include at least one of a size of the sparse index or information related to an amount of data on the back end node.

FIG. 6 is a block diagram of an example computer system 600 to select a winning bid using a front end node. These various blocks may be implemented in hardware, firmware, or software as part of the front end node 207. Illustrated is a CPU 601 operatively connected to a memory 602. Operatively connected to the CPU 601 is a sampling module 603 to sample a plurality of hashes associated with a segment of data to generate at least one hook. Operatively connected to the CPU 601 is a transmission module 604 to broadcast the at least one hook to a plurality of back end nodes. Operatively connected to the CPU 601 is a receiving module 605 to receive a plurality of bids from the plurality of back end nodes, each bid of the plurality of bids representing a number of hooks found by one of the plurality of back end nodes. Operatively connected to the CPU 601 is a bid analysis module 606 to select a winning bid of the plurality of bids. In some example embodiments, the sampling includes using a bit pattern to identify hashes of a plurality of hashes. Further, in some example embodiments, each of the plurality of hashes is a hash of a chunk associated with the segment of data. Operatively connected to the CPU 601 is a transmission module 607 to transmit the segment to the back end node that provided the winning bid to be de-duplicated. In some example embodiments, the transmission module 607 transmits a chunk associated with the segment to the back end node 212 that provided the winning bid for storing. In some example embodiments, the winning bid is a bid that is associated with a numeric value that is larger than or equal to the other numeric values associated with the plurality of bids.

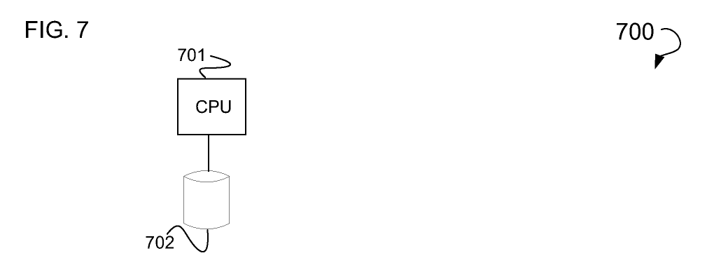

FIG. 7 is a block diagram of an example computer system 700 to select a winning bid using a front end node. These various blocks may be implemented in hardware, firmware, or software as part of the front end node 207. Illustrated is a CPU 701 operatively connected to a memory 702 including logic encoded in one or more tangible media for execution. The logic including operations that are executed to receive a set of hashes that is generated from a set of chunks associated with a segment of data. Further, the logic includes operations that are executed to search for at least one hash in the set of hashes as a key value in a sparse index. Additionally, the logic includes operations executed to bid, based upon a result of the search. Further, in some example embodiments, the set of hashes is a selected from a plurality of hashes using a sampling method, the plurality of hashes generated from the set of chunks associated with the segment of data. The bid may also be based upon a number of matches found during the search. Additionally, the bid may include at least one of a size of the sparse index, or information related to an amount of data.

In one example embodiment, the logic also includes operations that are executed to receive the segment of data, and de-duplicate the segment of data through the identification of a chunk, of the set of chunks associated with the segment of data, that is already stored in a data store. In another example embodiment, the logic instead also includes operations executed to receive a further set of hashes. Moreover, the logic includes operations executed to identify a hash, of the further set of hashes, whose associated chunk is not stored in a data store. The logic also includes operations executed to store the associated chunk. In some example embodiments, the set of hashes and the further set of hashes are identical.

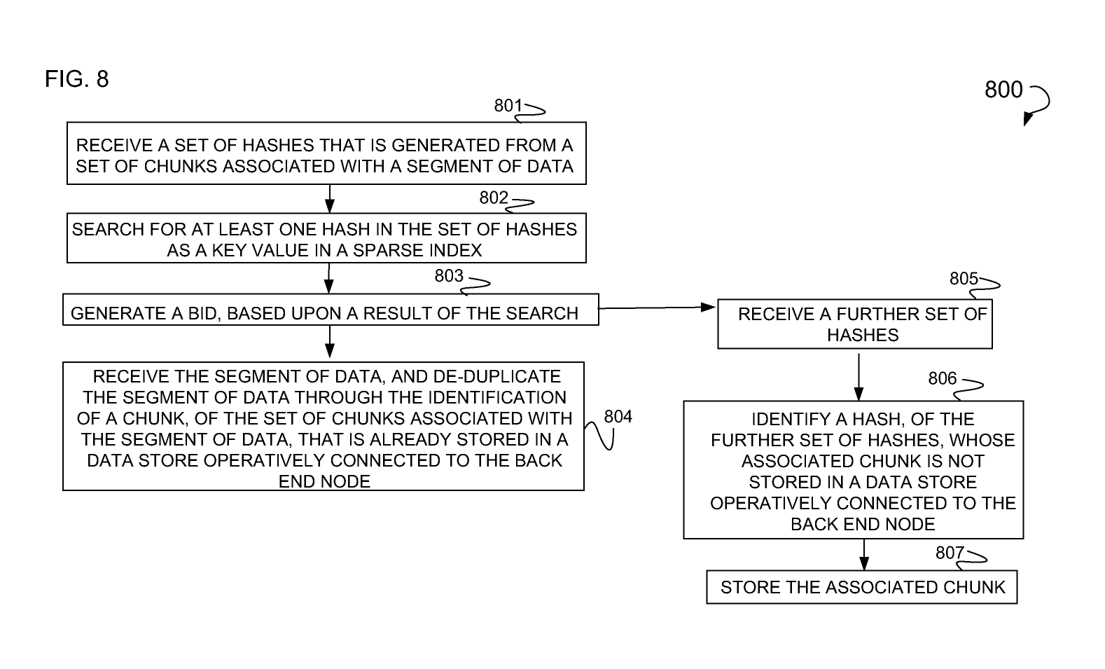

FIG. 8 is a flow chart illustrating an example method 800 to generate bids for auction based sparse index routing using a back end node. This method 800 may be executed by the back end node 212. Operation 801 is executed by the receiving module 503 to receive a set of hashes that is generated from a set of chunks associated with a segment of data. Operation 802 is executed by the lookup module 504 to search for at least one hash in the set of hashes as a key value in a sparse index. Operation 803 is executed by the bid module 505 to generate a bid, based upon a result of the search. Additionally, the set of hashes may be selected from a plurality of hashes using a sampling method, the plurality of hashes generated from the set of chunks associated with the segment of data. Further, in some example embodiments, the bid module bases the bid on a number of matches found by the lookup module. The bid may include at least one of a size of the sparse index or information related to an amount of data on the back end node. In one example embodiment, an operation 804 is executed by the de-duplication module 506 to receive the segment of data, and de-duplicate the segment of data through the identification of a chunk, of the set of chunks associated with the segment of data, that is already stored in a data store operatively connected to the back end node.

In another alternative example embodiment, operations 805-807 are instead executed. An operation 805 is executed by the de-duplication module 506 to receive a further set of hashes. An operation 806 is executed by the de-duplication module 506 to identify a hash, of the further set of hashes, whose associated chunk is not stored in a data store operatively connected to the back end node. Operation 807 is executed by the de-duplication module 506 to store the associated chunk. In some example embodiments, the further set of hashes is received from the receiving module, and the set of hashes and the further set of hashes are identical.

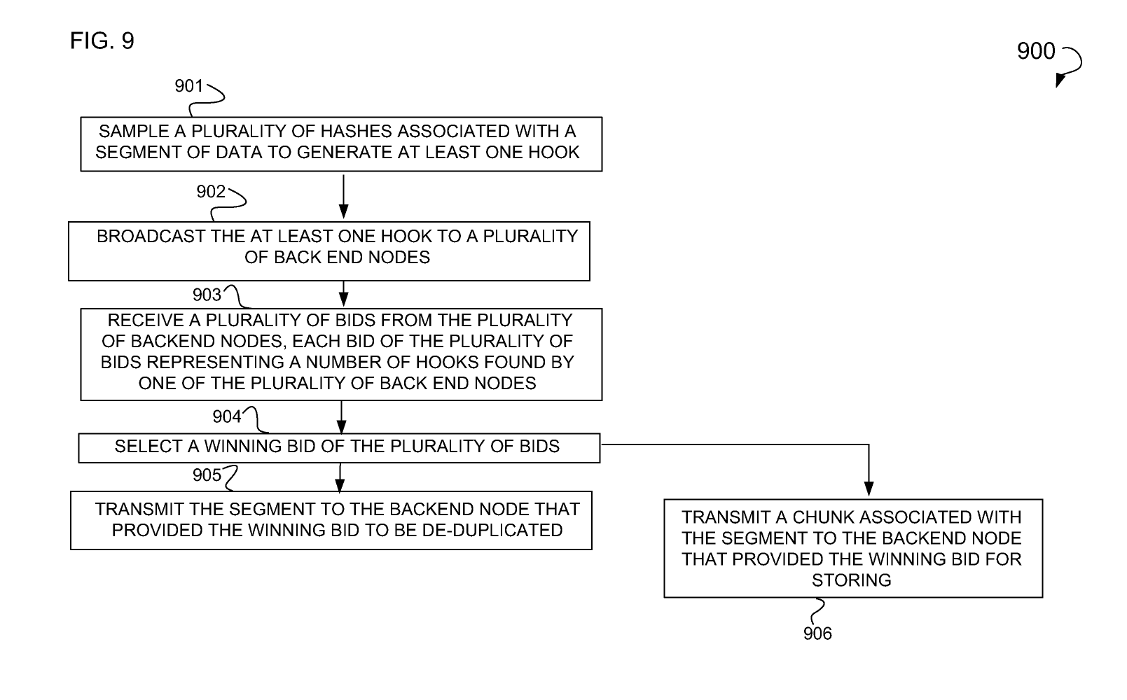

FIG. 9 is a flow chart illustrating an example method 900 to select a winning bid using a front end node. This method 900 may be executed by the front end node 207. Operation 901 is executed by the sampling module 603 to sample a plurality of hashes associated with a segment of data to generate at least one hook. Operation 902 is executed by the transmission module 604 to broadcast the at least one hook to a plurality of back end nodes. Operation 903 is executed by the receiving module 605 to receive a plurality of bids from the plurality of back end nodes, each bid of the plurality of bids representing a number of hooks found by one of the plurality of back end nodes. Operation 904 is executed by the bid analysis module 606 to select a winning bid of the plurality of bids. In some example embodiments, sampling includes using a bit pattern to identify hashes of a plurality of hashes. In some example embodiments, each of the plurality of hashes is a hash of a chunk associated with the segment of data. In some example embodiments, the winning bid is a bid that is associated with a numeric value that is larger than or equal to the other numeric values associated with the plurality of bids.

In one example embodiment, an operation 905 is executed using the transmission module 607 to transmit the segment to the back end node that provided the winning bid to be de-duplicated. In another example embodiment, operation 906 is executed instead by the transmission module 607 to transmit a chunk associated with the segment to the back end node that provided the winning bid for storing.

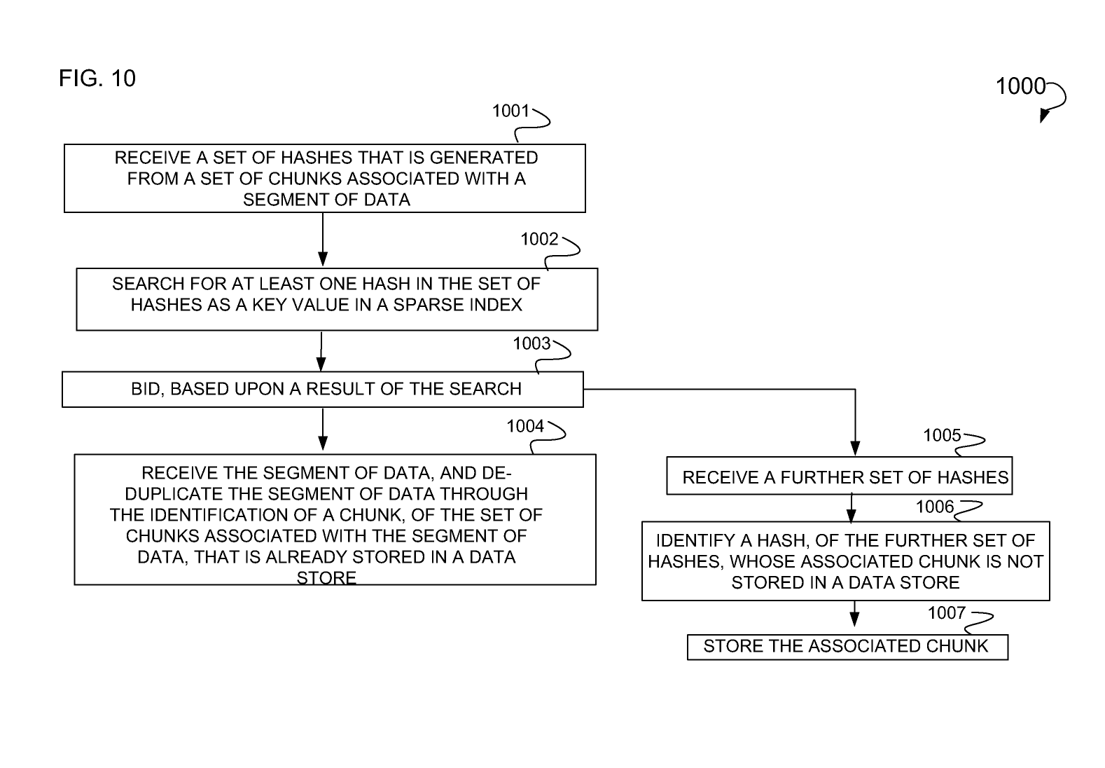

FIG. 10 is a flow chart illustrating an example method 1000 encoded on a computer readable medium to select a winning bid using a front end node. This method 1000 may be executed by the front end node 207. Operation 1001 is executed by the CPU 701 to receive a set of hashes that is generated from a set of chunks associated with a segment of data. Operation 1002 is executed by the CPU 701 to search for at least one hash in the set of hashes as a key value in a sparse index. Operation 1003 is executed by the CPU 701 to bid, based upon a result of the search. Further, in some example embodiments, the set of hashes is a selected from a plurality of hashes using a sampling method, the plurality of hashes generated from the set of chunks associated with the segment of data. Additionally, in some example embodiments, the bid is based upon a number of matches found during the search. In some example embodiments, the bid includes at least one of a size of the sparse index, or information related to an amount of data.

In one example embodiment, an operation 1004 is executed by the CPU 701 to receive the segment of data, and de-duplicate the segment of data through the identification of a chunk, of the set of chunks associated with the segment of data, that is already stored in a data store. In another example embodiment, operations 1005 through 1007 are executed instead. Operation 1005 is executed by the CPU 701 to receive a further set of hashes. Operation 1006 is executed by the CPU 701 to identify a hash, of the further set of hashes, whose associated chunk is not stored in a data store. Operation 1007 is executed by the CPU 701 to store the associated chunk. In some example embodiments, the set of hashes and the further set of hashes are identical.

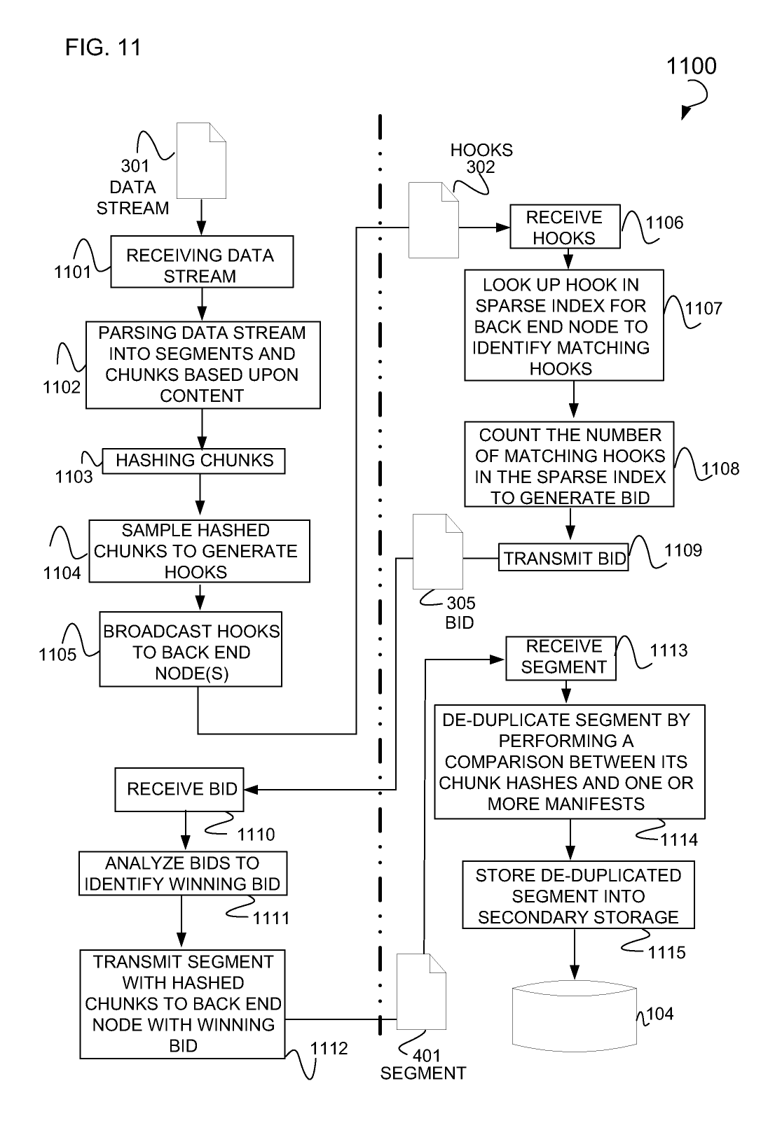

FIG. 11 is a dual-stream flow chart illustrating example method 1100 to bid for, and to de-duplicate data, prior to storage within an auction-based sparse index routing system. Shown are operations 1101 through 1105, and 1110 through 1112 executed by a front end node such as front end node 207. Also shown are operations 1106 through 1109 executed by all of the back end nodes, and operations 1113 through 1115 executed by one of the back end nodes such as back end node 212. Shown is the data stream 301 that is (partially) received through the execution of operation 1101. An operation 1102 is executed that parses the data stream received so far into segments and chunks based upon the content contained within the data stream 301. Operation 1103 is executed that hashes each of these chunks, resulting in a plurality of hashes. Operation 1104 is executed that samples the hashes of one of the segments to generate hooks. A sampling rate may be determined by a system administrator or through the use of a sampling algorithm. Sampling may be at a rate of 1/128, 1/64, 1/32 or some other suitable rate. The sampling may be based upon a sampling characteristic such as a bit pattern associated with the hash. A bit pattern may be the first seven, eight, nine or ten bits in a hash. Operation 1105 is executed to broadcast the hooks to the back end nodes such as back end nodes 210 through 212.

Operation 1106 is executed to receive hook(s) 302. Operation 1107 is executed to look up the hook(s) 302 in a sparse index residing on the given particular back end node, and to identify which of these hook(s) 302 are contained in the sparse index. Operation 1108 is executed to count the number of found hook(s) in the sparse index, where this count (e.g., a count value) serves as a bid such as bid 305. In some example embodiments, the results of looking up the hook(s) 302, including one or more pointer values associated with the hook(s) 302, are used to lieu of the found hooks alone as a basis for generating a bid count value. Operation 1109 is executed transmit the count value as a bid such as bid 305. Bids are received from one or more back ends through the execution of operation 1110.

In some example embodiments, an operation 1111 is executed to analyze the received bids to identify a winning bid amongst the various submitted bids. For example, bid 305 may be the winning bid amongst the set of submitted bids that includes bids 303 and 304. Operation 1112 is executed to transmit the segment (e.g., segment 401) to the back end node that submitted the winning bid. This transmission may be based upon the operation 1110 receiving an identifier for this back end node that uniquely identifies that back end node. This identifier may be a Globally Unique Identifier (GUID), an Internet Protocol (IP) address, a numeric value, or an alpha-numeric value. Operation 1113 is executed to receive the segment 401. Operation 1114 is executed to de-duplicate the segment 401 through performing a comparison (e.g., a hash comparison) between the hashes of the chunks making up the segment and the hashes of one or more manifests found via looking up the hook(s) 302 earlier. Where a match is found, the chunk with that hash in the segment 401 is discarded. Operation 1115 is executed to store the remaining (that is, not found to be duplicates of already stored chunks) chunks of the segment 401 in the secondary storage 104.

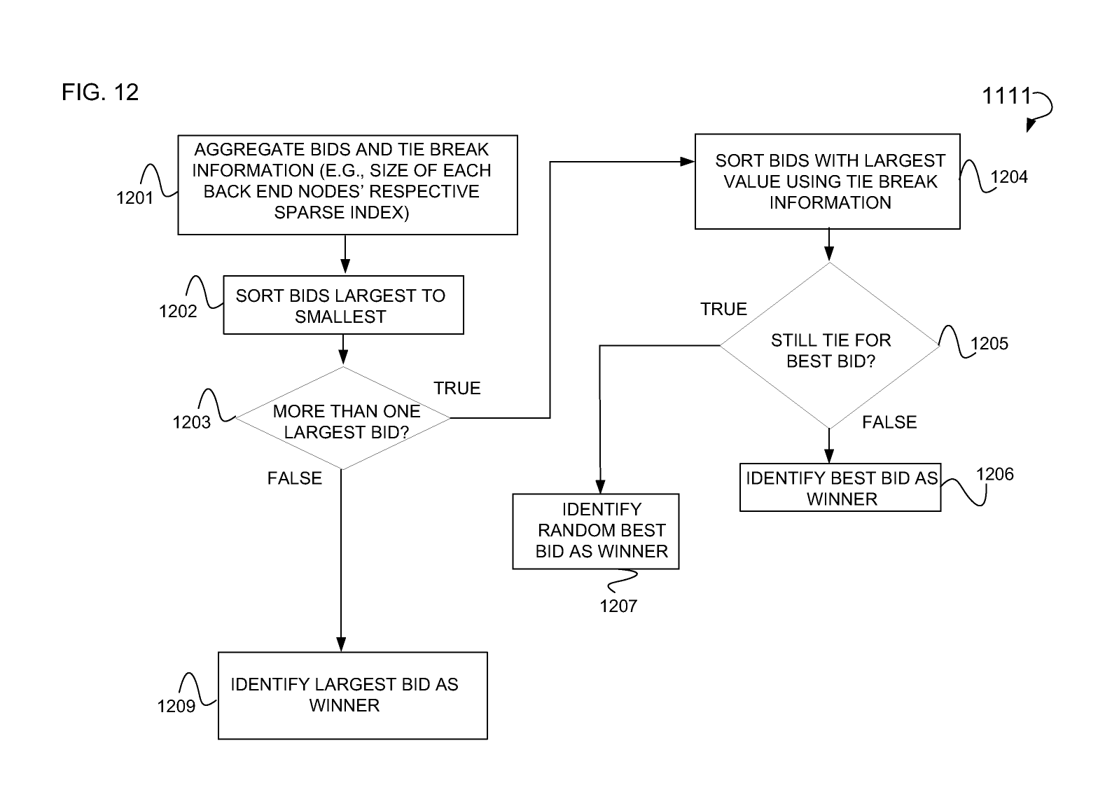

FIG. 12 is a diagram of an example operation 1111. Shown is an operation 1201 that is executed to aggregate bids and tiebreak information associated with each respective back end node. This tiebreak information may be the size of each respective back end node sparse index, or the total size of data stored on each back end node. As used herein, size includes a unit of information storage that includes kilobytes (KB), megabytes (MB), gigabytes (GB), or some other suitable unit of information storage. Operation 1202 is executed to sort the submitted bids largest to smallest. A decisional operation 1203 is executed that determines whether there is more than one largest bid. In cases where decisional operation 1203 evaluates to “true,” an operation 1204 is executed. In cases where decisional operation 1203 evaluates to “false,” an operation 1209 is executed. Operation 1209, when executed, identifies the largest bid (there will be only one such bid in this case) as the winner. This identifier may be a hexadecimal value used to uniquely identify one of the back end nodes 210 through 212.

Operation 1204 is executed to sort just the bids with the largest value using the tiebreak information. In particular, operation 1204 may sort these bids so that bids from back ends with associated high tie-breaking information (e.g., back ends with large sparse indexes or a lot of already stored data) come last. That is, largest bids associated with lower tie-breaking information are considered better. A decisional operation 1205 is executed to determine whether there still is a tie for the best bid. In cases where decisional operation 1205 evaluates to “true,” an operation 1207 is executed. In cases where decisional operation 1205 evaluates to “false,” an operation 1206 is executed. Operation 1206 is executed to identify the best bid (there is only one best bid in this case) as the winner. Operation 1207 is executed to identify a random one of the best bids as the winner.

In another example embodiment, the winning bid may be one of the smallest bids. In this case, a similar sequence of steps to that shown in FIG. 12 is performed except that wherever the word “largest” appears, the word “smallest” is substituted.

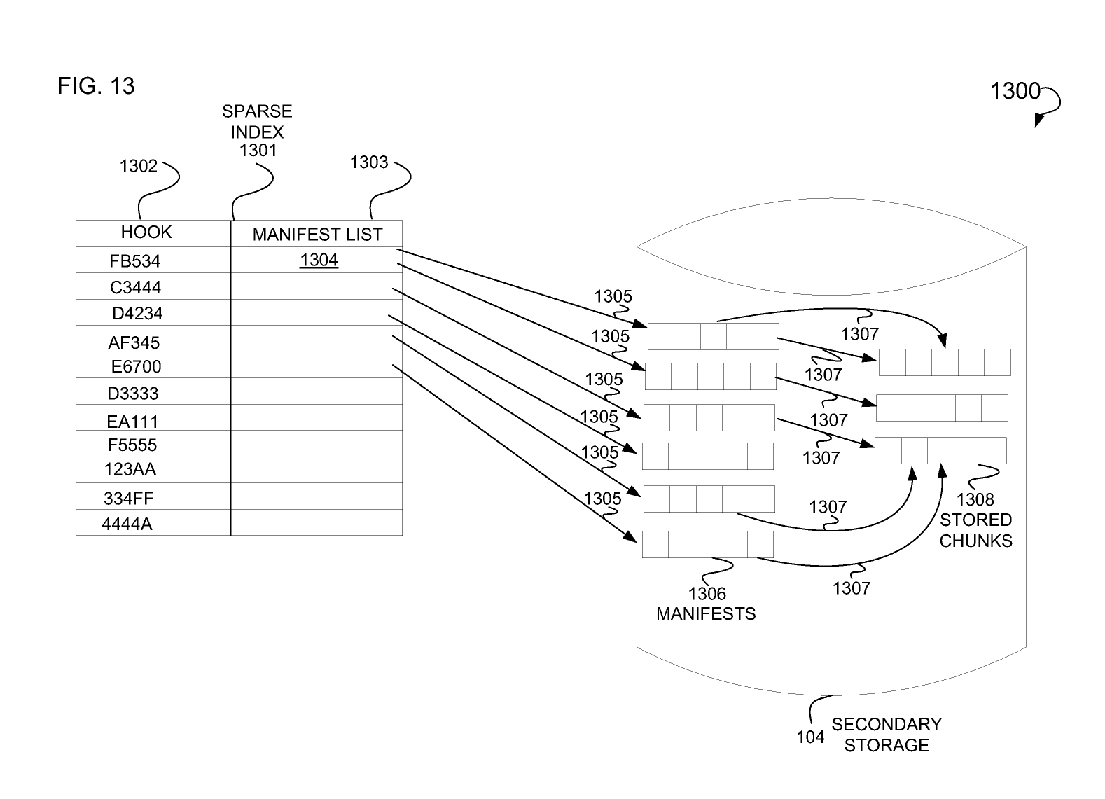

FIG. 13 is a diagram illustrating an example system 1300 containing a sparse index 1301. Shown is a sparse index 1301 that includes a hook column 1302 and a manifest list column 1303. The hook column 1302 includes for each row a unique hash value that identifies a sampled chunk of data. This hook column 1302 is the key field of the sparse index 1301. That is, the sparse index maps each of the hashes found in the hook column to the associated value found in the manifest list column of the same row. For example, the index maps the hash FB534 to the manifest list 1304. The hashes thus serve as key values for the sparse index 1301. The sparse index 1301 may be implemented as a data structure known as a hash table for efficiency. Note that in practice the hashes would have more digits than shown in FIG. 13.

Included in the manifest lists column 1303 is an entry 1304 that serves as the value for hook FB534. The combination of the entries on the hook column 1302 and the entries in the manifest list column 1303 serve as a RAM key-value map. The entry 1304 includes, for example, two pointers 1305 that point to two manifests 1306 that reside in the secondary storage 104. More than two pointers or only one pointer may alternatively be included as part of the entry 1304. In some example embodiments, a plurality of pointers may be associated with some entries in the hooks column 1302. Not shown in FIG. 13 are manifest pointers for the last six rows (i.e., D3333 through 4444A).

In some example embodiments, associated with each of the manifests 1306 is a sequence of hashes. Further, metadata relating to the chunks with those hashes may also be included in each of the manifests 1306. For example, the length of a particular chunk, and a list of pointers 1307 pointing from the manifest entries to the actual chunks (e.g., referenced at 1308) stored as part of each of the entries in the manifests 1306. Only selected pointers 1307 are shown in FIG. 13.

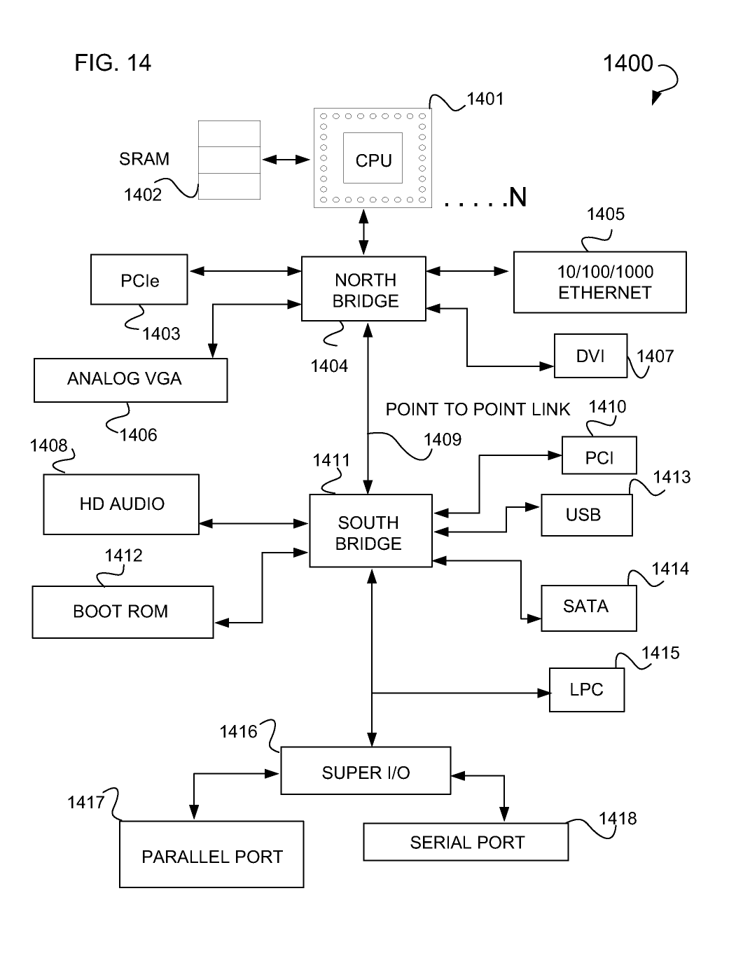

FIG. 14 is a diagram of an example computer system 1400. Shown is a CPU 1401. In some example embodiments, a plurality of CPU may be implemented on the computer system 1400 in the form of a plurality of core (e.g., a multi-core computer system), or in some other suitable configuration. Some example CPUs include the x86 series CPU. Operatively connected to the CPU 1401 is Static Random Access Memory (SRAM) 1402. Operatively connected includes a physical or logical connection such as, for example, a point to point connection, an optical connection, a bus connection or some other suitable connection. A North Bridge 1404 is shown, also known as a Memory Controller Hub (MCH), or an Integrated Memory Controller (IMC), that handles communication between the CPU and PCIe, Dynamic Random Access Memory (DRAM), and the South Bridge. A PCIe port 1403 is shown that provides a computer expansion port for connection to graphics cards and associated GPUs. An ethernet port 1405 is shown that is operatively connected to the North Bridge 1404. A Digital Visual Interface (DVI) port 1407 is shown that is operatively connected to the North Bridge 1404. Additionally, an analog Video Graphics Array (VGA) port 1406 is shown that is operatively connected to the North Bridge 1404. Connecting the North Bridge 1404 and the South Bridge 1411 is a point to point link 1409. In some example embodiments, the point to point link 1409 is replaced with one of the above referenced physical or logical connections. A South Bridge 1411, also known as an I/O Controller Hub (ICH) or a Platform Controller Hub (PCH), is also illustrated. Operatively connected to the South Bridge 1411 are a High Definition (HD) audio port 1408, boot RAM port 1412, PCI port 1410, Universal Serial Bus (USB) port 1413, a port for a Serial Advanced Technology Attachment (SATA) 1414, and a port for a Low Pin Count (LPC) bus 1415. Operatively connected to the South Bridge 1411 is a Super Input/Output (I/O) controller 1416 to provide an interface for low-bandwidth devices (e.g., keyboard, mouse, serial ports, parallel ports, disk controllers). Operatively connected to the Super I/O controller 1416 is a parallel port 1417, and a serial port 1418.

The SATA port 1414 may interface with a persistent storage medium (e.g., an optical storage devices, or magnetic storage device) that includes a machine-readable medium on which is stored one or more sets of instructions and data structures (e.g., software) embodying or utilized by any one or more of the methodologies or functions illustrated herein. The software may also reside, completely or at least partially, within the SRAM 1402 and/or within the CPU 1401 during execution thereof by the computer system 1400. The instructions may further be transmitted or received over the 10/100/1000 ethernet port 1405, USB port 1413 or some other suitable port illustrated herein.

In some example embodiments, the methods illustrated herein may be implemented using logic encoded on a removable physical storage medium. The term medium is a single medium, and the term “machine-readable medium” should be taken to include a single medium or multiple medium (e.g., a centralized or distributed database, and/or associated caches and servers) that store the one or more sets of instructions. The term “machine-readable medium” or “computer-readable medium” shall also be taken to include any medium that is capable of storing, encoding or carrying a set of instructions for execution by the machine and that cause the machine to perform any of the one or more of the methodologies illustrated herein. The term “machine-readable medium” or “computer-readable medium” shall accordingly be taken to include, but not be limited to, solid-state memories, optical and magnetic medium, and carrier wave signals.

Data and instructions (of the software) are stored in respective storage devices, which are implemented as one or more computer-readable or computer-usable storage media or mediums. The storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as CDs or DVDs. Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations there from. It is intended that the appended claims cover such modifications and variations as fall within the “true” spirit and scope of the invention.

What is claimed is:

1. A computer system comprising:
a receiving module, which resides on a back end node, to receive a set of hashes that is generated from a set of chunks associated with a segment of data;
a lookup module, which resides on the back end node, to search for at least one hash in the set of hashes as a key value in a sparse index; and
a bid module, which reside on the back end node, to generate a bid, based upon a result of the search.

2. The computer system of claim 1, further comprising a de-duplication module, which resides on the back end node, that receives the segment of data, and de-duplicates the segment of data through the identification of a chunk, of the set of chunks associated with the segment of data, that is already stored in a data store operatively connected to the back end node.

3. The computer system of claim 1, further comprising a de-duplication module, which resides on the back end node, to:
receive a further set of hashes;
identify a hash, of the further set of hashes, whose associated chunk is not stored in a data store operatively connected to the back end node; and
store the associated chunk.

4. The computer system of claim 3, wherein the further set of hashes is received from the receiving module, and the set of hashes and the further set of hashes are identical.

5. The computer system of claim 1, wherein the set of hashes is a selected from a plurality of hashes using a sampling method, the plurality of hashes generated from the set of chunks associated with the segment of data.

6. The computer system of claim 1, wherein the bid module bases the bid on a number of matches found by the lookup module.

7. The computer system of claim 1, wherein the bid includes at least one of a size of the sparse index or information related to an amount of data on the back end node.

8. A computer implemented method comprising:
sampling a plurality of hashes associated with a segment of data, using a sampling module, to generate at least one hook;
broadcasting the at least one hook, using a transmission module, to a plurality of back end nodes;
receiving a plurality of bids from the plurality of back end nodes, using a receiving module, each bid of the plurality of bids representing a number of hooks found by one of the plurality of back end nodes; and
selecting a winning bid of the plurality of bids, using a bid analysis module.

9. The computer implemented method of claim 8, wherein sampling includes using a bit pattern to identify hashes of a plurality of hashes.

10. The computer implemented method of claim 8, wherein each of the plurality of hashes is a hash of a chunk associated with the segment of data.

11. The computer implemented method of claim 8, further comprising transmitting the segment, using a transmission module, to the back end node that provided the winning bid to be de-duplicated.

12. The computer implemented method of claim 8, further comprising transmitting a chunk associated with the segment, using a transmission module, to the back end node that provided the winning bid for storing.

13. The computer implemented method of claim 8, wherein the winning bid is a bid that is associated with a numeric value that is larger than or equal to the other numeric values associated with the plurality of bids.

14. A computer system comprising:
a sampling module to sample a plurality of hashes associated with a segment of data to generate at least one hook;
a transmission module to broadcast the at least one hook to a plurality of back end nodes;
a receiving module to receive a plurality of bids from the plurality of back end nodes, each bid of the plurality of bids representing a number of hooks found by one of the plurality of back end nodes; and
a bid analysis module to select a winning bid of the plurality of bids.

15. The computer system of claim 14, wherein the winning bid is a bid that is associated with a numeric value that is larger than or equal to the other numeric values associated with the plurality of bids.
